(19) United States
(12) Patent Application Publication
(10) Pub. No.: US 2026/0278452 A1
(43) Pub. Date: Sep. 17, 2026

(54) ENHANCING ARTIFICIAL INTELLIGENCE DECISION-MAKING WITH SELF-REFLECTION AND FEEDBACK MECHANISMS

(71) Applicant: International Business Machines Corporation, Armonk, NY (US)

(72) Inventors: Bo Wen, Chappaqua, NY (US); Chen Wang, Chappaqua, NY (US); Huamin Chen, Newton, MA (US); Mark Wegman, Mt. Kisco, NY (US)

(21) Appl. No.: 19/078,452

(22) Filed: Mar. 13, 2025

(51) Int. Cl. G06N 20/00

(52) U.S. Cl. CPC G06N 20/00

(57) ABSTRACT

Examples described herein provide systems and methods for enhancing artificial intelligence decision-making with self-reflection and feedback mechanisms. Aspects include receiving a prompt from a user, generating, in response to the prompt, an output by a thought generator, where the thought generator is configured to utilize one or more large language models to generate the output, and calculating, by a thought assessor based at least on one or more historical self-reflection reports from an experience knowledgebase, a confidence score for an action specified in the output. Based on a determination that the confidence score of the output exceeds a threshold value, aspects include performing the action and observing an outcome of the action, generating a self-reflection report based on the prompt, the output, and the outcome, and storing the self-reflection report in the experience knowledgebase. Aspects further include fine-tuning the thought generator based on the outcome of the action.

### BACKGROUND

The disclosure relates to artificial intelligence technologies, specifically methods and systems for enhancing artificial intelligence decision-making with self-reflection and feedback mechanisms.

In recent years, the development of artificial intelligence (AI) systems has gained significant attention, particularly in complex domains such as healthcare, autonomous vehicles, and financial trading. These systems mimic human cognitive processes to make informed decisions and adapt to new situations. However, a significant challenge lies in enabling these systems to learn and improve over time in a manner that is safe, transparent, and auditable. Traditional learning techniques often struggle to balance specialization in specific domains with the ability to consider a broader context, which is important for accurate decision-making.

Existing AI systems frequently lack robust mechanisms for assessing the potential outcomes of proposed actions, especially in high-stakes environments like healthcare, where inaccurate outputs can have severe consequences. Moreover, the ability of AI systems to learn from past experiences and apply this knowledge to future scenarios remains limited.

### SUMMARY

According to one aspect of the present invention, a computer-implemented method for enhancing artificial intelligence decision-making with self-reflection and feedback mechanisms is provided. The method includes receiving a prompt from a user, generating, in response to the prompt, an output by a thought generator, where the thought generator is configured to utilize one or more large language models to generate the output, and calculating, by a thought assessor based at least on one or more historical self-reflection reports from an experience knowledgebase, a confidence score for an action specified in the output. Based on a determination that the confidence score of the output exceeds a threshold value, the method includes performing the action and observing an outcome of the action, generating a self-reflection report based on the prompt, the output, and the outcome, and storing the self-reflection report in the experience knowledgebase. The method further includes fine-tuning the thought generator based on the outcome of the action.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a block diagram illustrating a computing environment, according to one or more embodiments;

FIG. 2 is a block diagram illustrating a system for enhancing artificial intelligence decision-making with self-reflection and feedback mechanisms according to one or more embodiments;

FIG. 3 is a flow chart diagram illustrating an operation of the system for enhancing artificial intelligence decision-making with self-reflection and feedback mechanisms, according to one or more embodiments;

FIG. 4 is a flow chart diagram illustrating a method for assessing a current thought by a thought assessor according to an embodiment according to one or more embodiments;

FIG. 5 is a data flow diagram illustrating the process of system performance improvement through multiple learning cycles, according to one or more embodiments; and

FIG. 6 is a flow chart diagram illustrating a method for enhancing artificial intelligence decision-making with self-reflection and feedback mechanisms, according to one or more embodiments.

The detailed description explains embodiments of the disclosure, together with advantages and features, by way of example with reference to the drawings.

### DETAILED DESCRIPTION

According to one aspect of the present invention, a computer-implemented method for enhancing artificial intelligence decision-making with self-reflection and feedback mechanisms is provided. The method includes receiving a prompt from a user, generating, in response to the prompt, an output by a thought generator, where the thought generator is configured to utilize one or more large language models to generate the output, and calculating, by a thought assessor based at least on one or more historical self-reflection reports from an experience knowledgebase, a confidence score for an action specified in the output. Based on a determination that the confidence score of the output exceeds a threshold value, the method includes performing the action and observing an outcome of the action, generating a self-reflection report based on the prompt, the output, and the outcome, and storing the self-reflection report in the experience knowledgebase. The method further includes fine-tuning the thought generator based on the outcome of the action. This arrangement provides a structured approach to AI decision-making, enabling the system to learn from past experiences and improve its performance over time. By incorporating self-reflection reports, the system can assess the likelihood of success for proposed actions, thereby reducing the risk of errors and enhancing decision accuracy. The method allows for dynamic adaptation, as the thought generator is fine-tuned based on real-world outcomes, ensuring that the AI system remains responsive to changing conditions and user needs. This continuous learning cycle enhances the system's ability to make informed decisions, particularly in complex environments where accurate and reliable outputs are of great importance. The integration of self-reflection reports into the decision-making process also provides transparency and auditability, facilitating human oversight and trust in AI systems.

According to one aspect of the present invention, the method further includes transmitting a rejection of the action to the thought generator based on a determination that the confidence score of the action does not exceed the threshold value. This mechanism ensures that only actions with a high likelihood of success are executed, thereby optimizing the decision-making process. By rejecting actions that do not meet the confidence threshold, the system conserves computational resources and avoids potential negative outcomes associated with low-confidence actions. This selective execution process enhances the overall efficiency and reliability of the AI system, as the focus is on actions that are more likely to yield positive results. Additionally, this approach allows the thought generator to refine proposals by learning from rejections, which improves the quality of future outputs. This feedback loop contributes to a more robust and adaptive AI system capable of making informed decisions in complex environments.

According to one aspect of the present invention, the method further includes providing feedback to the thought assessor based on the outcome of the action. This feedback mechanism allows the thought assessor to refine the evaluation process by incorporating real-world results into the decision-making framework. By doing so, the system can dynamically adjust its assessment criteria, leading to more accurate predictions of future actions. This iterative feedback loop enhances the system's ability to learn from past experiences, thereby improving overall decision-making accuracy and reliability. In practical applications, such as healthcare or financial trading, this capability ensures that the AI system can adapt to changing conditions and provide more precise recommendations, leading to better outcomes and increased trust in the system's decisions.

According to one aspect of the present invention, the method further includes fine-tuning the thought assessor based on the feedback. This process enhances the AI system's decision-making accuracy by iteratively refining the thought assessor's evaluation criteria using real-world outcomes. By incorporating feedback, the thought assessor can dynamically adjust assessment parameters, leading to more precise predictions of future actions. This iterative refinement process allows the system to learn from past experiences, improving the ability to generalize and adapt to new scenarios.

According to one aspect of the present invention, the fine-tuning the one or more of the thought assessor and the thought generator includes reinforcement learning techniques to iteratively improve a performance of the one or more of the thought assessor and the thought generator based on the feedback. This approach allows the AI system to dynamically adjust decision-making processes by incorporating real-world outcomes into the learning framework. By employing reinforcement learning, the system can autonomously identify successful actions and refine strategies to enhance future performance. This iterative improvement process enables the AI to adapt to new scenarios and optimize decision-making capabilities over time, leading to more accurate and reliable outputs. The integration of reinforcement learning techniques ensures that the system remains responsive to changing conditions and user needs, providing a robust mechanism for continuous learning and adaptation.

According to one aspect of the present invention, the confidence score is further based on data obtained from a domain specific knowledge database. This integration allows the thought assessor to access specialized information pertinent to the specific context of the proposed action, thereby enriching the assessment process with well-founded insights and expert knowledge. By leveraging domain-specific data, the system can more accurately evaluate the feasibility and potential impact of proposed actions, ensuring that decisions are grounded in relevant expertise. This approach enhances the reliability and precision of the confidence score, leading to more informed decision-making and reducing the likelihood of errors.

According to one aspect of the present invention, the threshold value is dynamically adjusted based on one or more of a context of the prompt and a historical performance of the thought generator. This dynamic adjustment allows the system to tailor decision-making criteria to the specific circumstances of each prompt, enhancing the adaptability and precision of the AI system. By considering the context, the system can better assess the relevance and importance of the prompt, leading to more accurate and contextually appropriate actions. Additionally, incorporating historical performance data of the thought generator enables the system to learn from past experiences, refining threshold settings to optimize decision-making over time. This approach ensures that the AI system remains responsive to varying conditions and user needs, improving overall effectiveness in complex environments. For example, in a healthcare application, the system might lower the threshold for significant diagnostic decisions to ensure higher accuracy, while in less significant scenarios, the threshold could be adjusted to allow for more exploratory actions. This flexibility enhances the system's ability to provide reliable and context-sensitive outputs.

According to one aspect of the present invention, a steering system is configured to observe the outcome of the action and generate the self-reflection report. This arrangement allows for a structured feedback loop within the AI system, enabling the AI to autonomously assess the effectiveness of its actions. By observing the outcomes, the steering system can provide detailed insights into the success or failure of actions, which are then documented in self-reflection reports. These reports serve as a historical record that the AI system can reference in future decision-making processes, enhancing the AI's ability to learn from past experiences. This setup not only improves the accuracy and reliability of the AI's decision-making capabilities but also ensures that the system can adapt to new scenarios by continuously updating the knowledge base with real-world outcomes. The integration of the steering system in this manner provides a mechanism for the AI to self-evaluate and refine processes, leading to more informed and effective actions over time.

According to one aspect of the present invention, the steering system is further configured to generate hypothetical feedback for a proposed actions that was not performed and update the self-reflection report based on the hypothetical feedback. This arrangement allows the AI system to simulate potential outcomes of actions that were considered but not executed, providing a broader perspective on decision-making. By incorporating hypothetical feedback, the system can refine decision-making processes even for actions that were not taken, enhancing the ability to learn from a wider range of scenarios. This capability enables the AI system to explore alternative strategies and outcomes, improving adaptability and robustness in dynamic environments. The hypothetical feedback mechanism ensures that the AI system can continuously update the knowledge base with insights from both actual and potential actions, leading to more informed and effective decision-making over time.

Existing AI systems frequently lack robust mechanisms for assessing the potential outcomes of proposed actions, especially in high-stakes environments like healthcare, where inaccurate outputs can have severe consequences. Moreover, the ability of AI systems to learn from past experiences and apply this knowledge to future scenarios remains limited. Current practices often involve human feedback reinforcement learning, where humans manually provide feedback, and models are retrained periodically. This approach is labor-intensive and does not allow AI systems to autonomously judge what is beneficial to learn and when to retrain based on accumulated data.

The present approach addresses these challenges by introducing a novel learning mechanism for brain-like AI architectures, focused on enhancing the learning and reasoning capabilities of AI systems. This approach involves a system structured around a thought generator and a thought assessor. The thought generator proposes actions based on prompts, while the thought assessor evaluates these proposals by checking various data sources, including self-reflection reports, domain knowledge databases, and potentially the internet. This system allows ai to remember past experiences to reduce future mistakes, moving beyond simple hallucination prevention to a more general learning and reasoning capability. The steering subsystem acts as a neutral arbiter, recording decisions and outcomes to provide feedback for future learning, thereby enabling the ai system to learn and improve autonomously.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

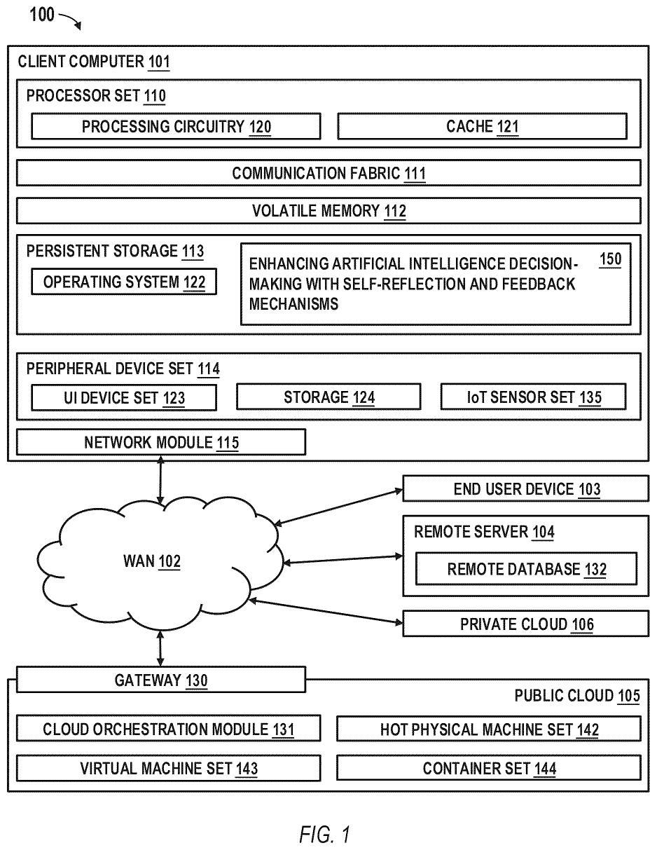

FIG. 1 illustrates a computing environment 100, according to an embodiment. Computing environment 100 contains an example of an environment for the execution of at least some of the computer code includes enhancing artificial intelligence decision-making with self-reflection and feedback mechanisms, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

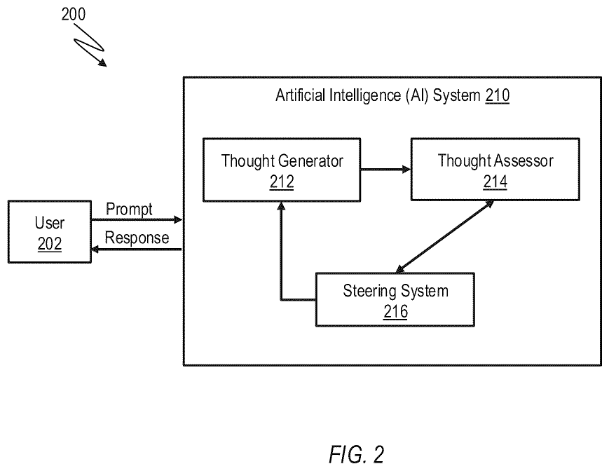

Referring now to FIG. 2, a block diagram illustrating a system 200 for enhancing artificial intelligence decision-making with self-reflection and feedback mechanisms in accordance with an embodiment is shown. The system 200 includes a user 202 that interacts with an AI system 210. In exemplary embodiments, the AI system 210 may be an artificial general intelligence AGI system. In exemplary embodiments, the AI system 210 is structured to improve decision-making capabilities through the interaction of the various components of the AI system 210. The AI system 210 includes a thought generator 212, thought assessor 214, and steering system 216, which together enable handling of user inputs, creation of responses, and enhancement of decision-making processes over time. The AI system 210 engages with a user 202, receiving prompts and delivering responses, facilitating a dynamic exchange of information and feedback.

In exemplary embodiments, the user 202 acts as the source of input for the AI system 210, providing prompts that trigger the decision-making process. These prompts are processed by the thought generator 212, which formulates potential responses or actions based on the input. The interaction between the user 202 and the AI system 210 initiates the operations of the thought generator 212 and the thought assessor 214. The user 202 not only provides input but also receives the responses generated by the AI system 210, completing the feedback loop and enabling continuous interaction and learning.

In exemplary embodiments, the thought generator 212 is configured to generate proposed actions or responses based on the input from the user 202. The thought generator 212 utilizes one or more language models to process the input data and produce potential outputs, which are then evaluated by the thought assessor 214. In exemplary embodiments, the thought generator 212 employs advanced language models, such as ChatGPT or similar architectures, to ensure that the generated proposals are contextually relevant and informed by current data.

In exemplary embodiments, the thought assessor 214 evaluates the proposals generated by the thought generator 212. The thought assessor 214 predicts the likelihood of a proposed action leading to a positive or negative outcome, using relevant context and historical self-reflection reports. The thought assessor 214 employs language models capable of retrieving and analyzing data from various sources, including self-reflection reports and domain knowledge databases. By assessing the potential outcomes of proposed actions, the thought assessor 214 ensures that viable proposals are accepted and acted upon. In exemplary embodiments, the feedback from the thought assessor 214 is used to train the thought generator 212 to produce more accurate and effective decision-making.

In exemplary embodiments, the steering system 216 monitors the outcomes of accepted proposed actions and provides feedback to both the thought generator 212 and the thought assessor 214. In exemplary embodiments, the steering system 216 observes the real-world results of actions taken that relate to the request/prompts provided by the AI system 210 and assesses whether these actions lead to positive or negative outcomes. The feedback loop established by the steering system 216 allows for the adjustment of the thought generator 212's weights and the enhancement of the thought assessor 214's prediction accuracy. In exemplary embodiments, the steering system 216 may also be configured to provide hypothetical feedback for rejected proposals, offering insights into potential outcomes and further refining the decision-making process.

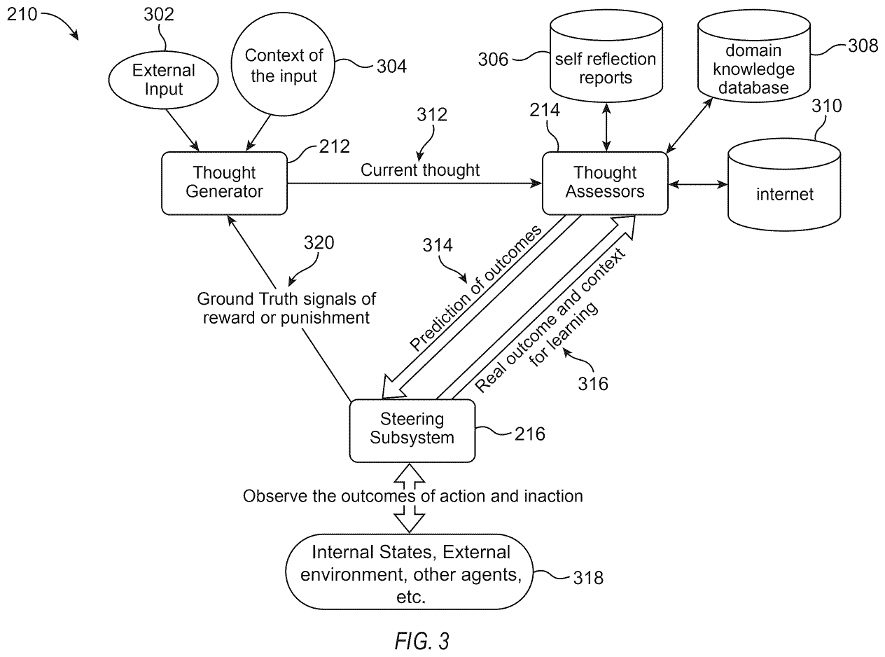

Referring now to FIG. 3, a flow chart diagram illustrating an operation of the AI system 210 for enhancing artificial intelligence decision-making with self-reflection and feedback mechanisms according to an embodiment is shown. The AI system 210 includes the thought generator 212, the thought assessor 214, and the steering subsystem 216. These components interact with various data sources, such as external input 302, context of the input 304, and the domain knowledge database 308, and each other to enhance decision-making processes.

In exemplary embodiments, to retrieve information from the experience knowledgebase, the system can employ several methods tailored to different needs and contexts, ensuring effective leverage of past experiences for current decision-making processes. One approach is direct lookup, which includes traditional keyword search and modern vector database similarity search. Keyword search involves scanning the stored self-reflection reports for specific terms, quickly finding reports related to particular topics or actions. In contrast, a vector database similarity search encodes each self-reflection report into a vector representation, capturing its semantic content. When a new task arises, it is also converted into a vector, and the system performs a similarity search to find past reports with vector representations closest to the current task. This method allows for retrieving experiences that are semantically similar, even without exact keyword matches, providing a more nuanced and context-aware retrieval. Another approach is the LLM query, or agentic way, where the ai system employs a large language model (LLM) to determine what kind of past experiences would be beneficial for the current task. Acting as an agent, the LLM analyzes the current context and decides which types of experiences to seek, using lookup tools like keyword search or vector similarity search to query the experience knowledgebase. This method can follow a self-similar recursive pattern, where the retrieval agent is a copy or specialized version of the ai system itself. This recursive pattern ensures consistency in decision-making, as the retrieval agent operates with the same capabilities and understanding as the main ai system. By autonomously deciding which past experiences are most relevant, the retrieval agent leverages its reasoning and learning capabilities to enhance the main system's performance. Through these methods, the ai system effectively accesses and applies historical knowledge stored in the experience knowledgebase, continuously improving its decision-making processes through informed assessments and actions.

In exemplary embodiments, the process begins with the External Input 302, which provides initial data or prompts to the thought generator 212. The external input 302 is accompanied by a context of the input 304, which provides additional information to help the thought generator 212 formulate a relevant response or action. The thought generator 212 processes this information to produce a current thought 312, which is then evaluated by the thought assessor 214.

In exemplary embodiments, the thought assessor 214 evaluates the current thought 312 generated by the thought generator 212. The thought assessor 214 utilizes multiple data sources to make informed assessments of the current thought 312. These data sources include self-reflection reports 306, which contain records of past actions and outcomes, one or more domain specific knowledge databases 308, which provide domain-specific information, and the Internet 310, which offers a broader range of knowledge. By accessing these resources, the thought assessor 214 can predict the potential outcomes of the proposed actions included in the current thought 312.

In an example, the AI system 210 is part of a healthcare application that is used to assist in medical diagnosis. The process begins with the external input, which could be a patient's symptoms and medical history. For instance, the input might state that “the patient is experiencing persistent headaches, nausea, and blurred vision.” Accompanying this input is the context, which provides additional information such as the patient's age, recent travel history, and any known allergies. An example of this context might be “the patient is a 45-year-old male with no known allergies, recently returned from a trip to a region with a high incidence of viral infections.” Based on the external input and its context, the thought generator 212 processes this information to produce a current thought. In this scenario, the thought generator 212 might propose a potential diagnosis or action, such as “consider the possibility of a viral infection like dengue fever, given the recent travel history and symptoms. Recommend conducting a blood test to check for viral markers and advise the patient to stay hydrated and rest.” This current thought 312 is then evaluated by the thought assessor 214, which utilizes self-reflection reports, domain-specific knowledge, and internet resources to assess the likelihood of the proposed diagnosis and action leading to a positive outcome.

In exemplary embodiments, the steering subsystem 216 is responsible for monitoring the outcomes of actions that are related to the current thought 312 provided by the AI system 210. The steering subsystem 216 observes the real-world results of actions and inactions, as indicated by the internal states, external environment, other agents, etc. 318. The steering subsystem 216 provides feedback to both the thought generator 212 and the thought assessor 214. This feedback includes ground truth signals of reward or punishment 320, which are used to refine the decision-making process. Additionally, the steering subsystem 216 provides real outcome and context for learning 316 to the thought assessor 214, allowing the thought assessor 214 to update predictions and improve future assessments.

Continuing with this above example, once the thought assessor 214 evaluates the proposed diagnosis and action, the steering subsystem 216 monitors the real-world outcomes of the actions taken by the medical professional. The steering subsystem 216 can access the patient's medical records to track the implementation of the recommended actions, such as conducting a blood test and advising the patient to stay hydrated and rest. It observes the results of these actions, such as the blood test outcomes and any changes in the patient's symptoms or overall health condition. The real-world outcome data collected by the steering subsystem 216 is then used to provide feedback to both the thought generator 212 and the thought assessor 214. If the diagnosis and treatment were successful, resulting in the patient's recovery, this positive outcome is recorded and used to reinforce the decision-making process of the thought generator 212. The feedback helps in tuning the weights of the thought generator, allowing it to generate more accurate and effective proposals in future scenarios. Similarly, the thought assessor 214 uses the outcome data to refine its prediction accuracy. By analyzing the real-world results, the thought assessor 214 can update its assessment criteria and improve its ability to generalize from past experiences. This continuous feedback loop ensures that the AI system 210 learns from each interaction, enhancing its performance over time and increasing its effectiveness in assisting medical professionals with accurate diagnoses and treatment recommendations.

In exemplary embodiments, the interaction between these components and data sources enables the AI system 210 to continuously learn and adapt. The thought generator 212, thought assessor 214, and steering subsystem 216 work together to ensure that the AI system 210 can make informed decisions based on a comprehensive understanding of past experiences, domain knowledge, and real-time feedback. This architecture allows the AI system 210 to enhance performance over time, increasing effectiveness in complex decision-making scenarios.

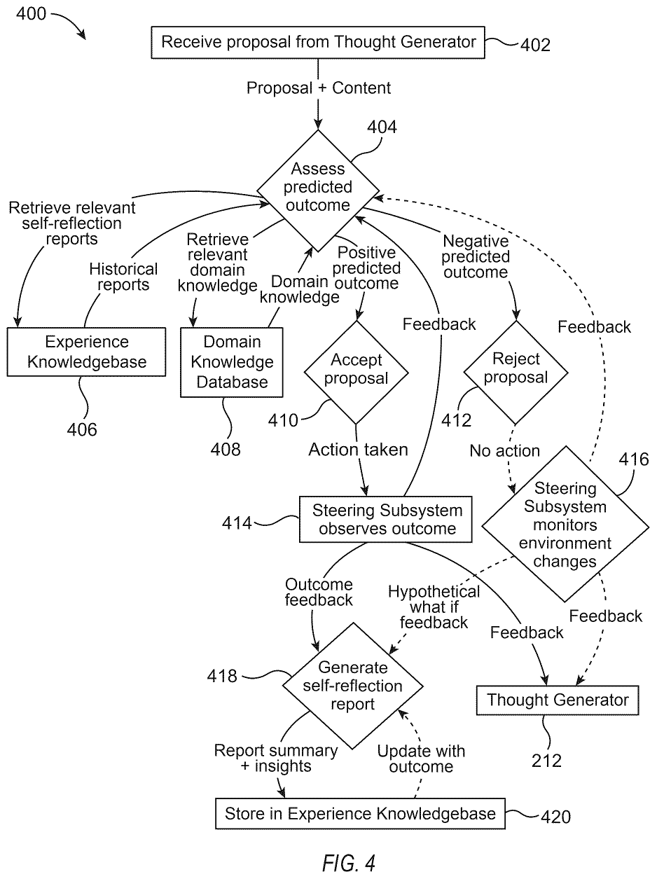

Referring now to FIG. 4, a flow chart diagram illustrating a method 400 for assessing a current thought by a thought assessor according to an embodiment is shown. The method 400 is performed by thought assessor 214, such as the one shown in FIG. 2. In exemplary embodiments, the method 400 begins with receiving a proposal, also referred to herein as a current thought, from a thought generator 212 and proceeds through various stages of assessment, feedback, and self-reflection to enhance the AI system's decision-making capabilities. In exemplary embodiments, the proposal includes a potential action or response generated based on input data and context. The proposal serves as the starting point for the assessment process, where the potential outcomes of the proposal are evaluated.

At step 404, the method 400 assesses the predicted outcomes of the proposal. This assessment involves retrieving relevant data from various sources, including self-reflection reports from an experience knowledgebase at step 406 and domain knowledge from a domain knowledge database at step 408. In exemplary embodiments, the assessment aims to predict the likelihood of positive or negative outcomes resulting from the proposed action. Next, as shown at step 410, the method 400 determines whether to accept the proposal based on the predicted outcomes. If the predicted outcome is positive, the proposal is accepted, and the action is taken, and the method 400 proceeds to step 414. However, if the predicted outcome is negative, as shown at step 412, the proposal is rejected, and the method 400 proceeds to step 416.

At step 414, the steering subsystem 216 observes the outcomes of the actions taken. This observation includes monitoring real-world results and gathering data on the effectiveness of the actions. The steering subsystem 216 provides feedback to the thought generator 212. At step 416, the steering subsystem 216 monitors environmental changes and provides hypothetical feedback for rejected proposals. This feedback offers insights into potential outcomes and helps refine the decision-making process, even for proposals that were not acted upon.

At step 418, the method 400 generates a self-reflection report based on the outcomes and feedback received. The self-reflection report summarizes the results and updates the experience knowledgebase with new data, ensuring that the AI system 210 learns from each interaction. At step 420, the self-reflection report is stored in the experience knowledgebase, ensuring that the AI system 210 retains the knowledge gained from past interactions. This storage enables the AI system 210 to enhance decision-making capabilities over time.

In one embodiment, the AI system is designed to continuously update the self-reflection report based on both actual and/or hypothetical feedback. This dynamic updating process ensures that the self-reflection report remains a living document, capturing the evolving understanding and learning of the AI system. After an action is performed, the steering subsystem provides feedback on the actual outcome, which is incorporated into the self-reflection report. This feedback includes insights into the success or failure of the action, allowing the AI system to refine its decision-making processes. Additionally, the self-reflection report can be updated with hypothetical feedback generated for rejected actions. This feedback simulates potential outcomes of actions that were not taken, offering a broader perspective on the decision-making landscape. By integrating both actual and hypothetical feedback, the self-reflection report becomes a comprehensive record of the AI system's learning journey, capturing not only what was done but also what could have been done.

For example, consider an AI system used in a healthcare application. Suppose the system proposes a treatment plan for a patient, but only one of the proposed actions is executed. The steering subsystem observes the patient's response to the treatment and provides actual feedback indicating that the treatment was successful. This feedback is added to the self-reflection report, reinforcing the decision to use that treatment. Simultaneously, the steering subsystem generates hypothetical feedback for the alternative treatments that were considered but not administered. It simulates potential patient outcomes for these treatments, suggesting that one might have been equally effective while another could have led to complications. This hypothetical feedback is also incorporated into the self-reflection report, providing valuable insights into the potential risks and benefits of the rejected options. By continuously updating the self-reflection report with both actual and hypothetical feedback, the AI system enhances its ability to learn from each interaction. This comprehensive approach ensures that the system not only retains knowledge from past experiences but also gains a deeper understanding of the decision-making process, ultimately improving its performance and adaptability over time.

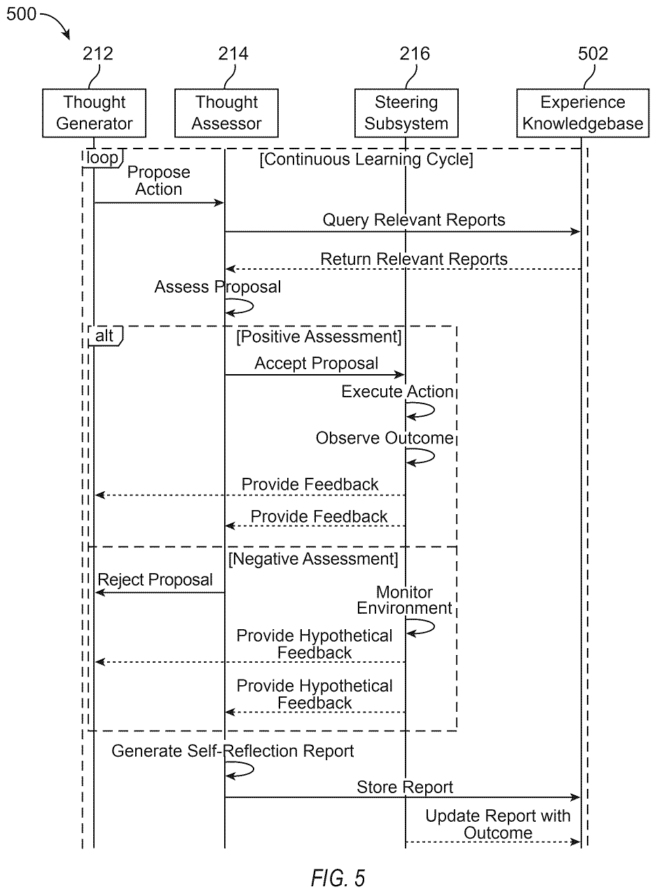

Referring now to FIG. 5, a data flow diagram 500 illustrating the process of system performance improvement through multiple learning cycles in accordance with an embodiment is shown. The diagram 500 illustrates the exchange of data between the thought generator 212, the thought assessor 214, the steering subsystem 216, and the experience knowledgebase 502. These components interact to enhance decision-making capabilities by continuously learning from feedback and outcomes. The data exchange between the thought generator 212, the thought assessor 214, the steering subsystem 216, and the experience knowledgebase 502 is used for the continuous learning and improvement of the AI system. The process begins with the thought generator 212 sending proposed actions or responses to the thought assessor 214. This proposal data includes initial suggestions generated based on input data and context, which the thought assessor 214 evaluates for potential outcomes. To inform its assessment, the thought assessor 214 queries the experience knowledgebase 502 to retrieve relevant self-reflection reports and historical data. The experience knowledgebase 502 responds by providing past proposals, outcomes, and insights that are semantically similar to the current proposal, aiding in the assessment process.

Once the thought assessor 214 completes its evaluation, it sends the assessment results to the steering subsystem 216, indicating the predicted outcomes of the proposed actions and whether they are likely to lead to positive or negative results. The steering subsystem 216 then provides feedback to both the thought generator 212 and the thought assessor 214 based on the real-world outcomes of executed actions. This feedback includes ground truth signals of reward or punishment, which are used to refine the decision-making processes of both components. Additionally, for rejected proposals, the steering subsystem 216 may offer hypothetical feedback, providing insights into what might have occurred if the proposal had been accepted, thus helping to refine future proposals and assessments.

The steering subsystem 216 also updates the experience knowledgebase 502 with the real-world outcomes of executed actions, ensuring that the knowledgebase is continuously enriched with new experiences. This update enhances the system's ability to learn from past interactions. Furthermore, the thought assessor 214 generates self-reflection reports based on the outcomes and feedback received, which are stored in the experience knowledgebase 502. These reports summarize the proposal, assessment context, final outcome, and insights for improvement. This comprehensive data exchange facilitates a continuous learning cycle, allowing the AI system to enhance its decision-making capabilities over time by leveraging past experiences, real-world outcomes, and feedback.

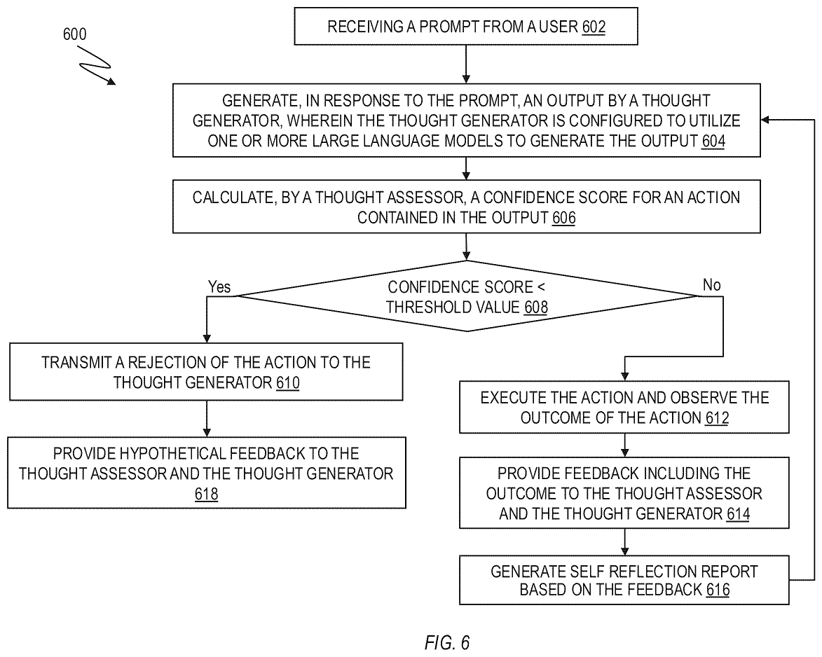

Referring now to FIG. 6, a flow chart illustrating a method 600 for enhancing artificial intelligence decision-making with self-reflection and feedback mechanisms according to one or more embodiments is shown. The method 600 can be implemented by an AI system 210, such as the one shown in FIG. 2. The method 600 begins at block 602 by receiving an external input, which serves as the initial data or prompt for the system. This input establishes the context for the subsequent operations and guides the decision-making process.

Next, as shown at block 604, the method 600 includes generating a current thought by a thought generator 212 in response to the external input. In exemplary embodiments, the thought generator utilizes one or more language models to formulate potential actions or responses. This step leverages the capabilities of the thought generator to interpret the input and produce a relevant proposal, drawing on its training and contextual understanding.

Following the generation of the current thought by the thought generator, at block 606, the method 600 includes calculating, by a thought assessor, a confidence score for an action contained in the output. In exemplary embodiments, the thought assessor retrieves relevant data from self-reflection reports, domain knowledge databases, and internet resources to assess the likelihood of the proposed action leading to a positive outcome and generates a score that quantifies the likelihood of the proposed action leading to a positive outcome. This evaluation marks the transition from proposal generation to assessment, where the thought assessor applies various criteria to determine the viability of the proposed action.

In the process of calculating a confidence score for an action contained in the output, the thought assessor may employ a multifaceted approach to evaluate the likelihood of the proposed action leading to a positive outcome. This evaluation begins with the retrieval of relevant data from various sources, including self-reflection reports, domain knowledge databases, and internet resources. These sources provide a comprehensive foundation of historical data, expert insights, and up-to-date information that inform the assessment process.

In exemplary embodiments, the thought assessor first analyzes self-reflection reports, which contain records of past actions and their outcomes. By identifying patterns and correlations in these reports, the thought assessor can draw parallels between the current proposal and similar past scenarios, providing a historical context for the evaluation. This historical analysis helps in understanding the potential consequences of the proposed action based on previous experiences. Next, the thought assessor accesses domain knowledge databases, which offer specialized information pertinent to the specific context of the proposal. These databases contain expert knowledge, best practices, and case studies that enhance the thought assessor's ability to evaluate the proposal's feasibility and potential impact. By integrating domain-specific insights, the thought assessor ensures that the evaluation is grounded in authoritative and relevant expertise. Additionally, the thought assessor utilizes internet resources to gather the latest information and trends that may influence the proposal's outcome. This step allows the thought assessor to incorporate a broader perspective, considering external factors and emerging developments that could affect the decision-making process.

Once the relevant data is gathered, the thought assessor applies various criteria and heuristics to synthesize the information and generate a confidence score. This score quantifies the likelihood of the proposed action leading to a positive outcome, serving as an indicator of the proposal's viability. The confidence score is calculated by weighing the insights from each data source, considering factors such as historical success rates, expert recommendations, and current trends. This comprehensive evaluation process ensures that the confidence score accurately reflects the potential success of the proposed action, guiding the subsequent decision-making steps.

In one example, an AI system is tasked with recommending a treatment plan for a patient based on their symptoms and medical history. The Thought Generator proposes an action: “administer drug A for treating the patient's condition.” to determine the viability of this action, the thought assessor calculates a confidence score. The process begins with retrieving relevant self-reflection reports, which contain records of past actions and their outcomes. By analyzing these reports, the thought assessor identifies patterns and correlations between similar past scenarios and the current proposal, yielding a score of 0.8, indicating a high likelihood of success based on historical data. Next, the thought assessor accesses a domain-specific knowledge database to gather expert insights, best practices, and case studies related to the proposed action. This database provides authoritative information on the feasibility and potential impact of administering drug a, resulting in a score of 0.6, reflecting moderate support for the action based on expert recommendations. The thought assessor then calculates the overall confidence score by combining the scores from the self-reflection reports and the domain knowledge database. Given the higher reliability of the self-reflection reports, they are assigned a weight of 0.7, while the domain knowledge database is assigned a weight of 0.3. The weighted confidence score is calculated as confidence score=(0.8×0.7)+(0.6×0.3)=0.74. The thought assessor compares this calculated confidence score of 0.74 to a predefined threshold value, such as 0.7. Since the confidence score exceeds the threshold, the proposed action is considered viable, and the system proceeds to execute the action. This example illustrates how the thought assessor synthesizes information from multiple sources, applies weighted criteria, and generates a confidence score to guide decision-making. By prioritizing insights from self-reflection reports, the system leverages historical success rates to enhance the reliability of its recommendations.

In exemplary embodiment, the thought assessor calculates the overall confidence score by combining the scores from the self-reflection reports and the domain knowledge database. Given the higher reliability of the self-reflection reports, they are typically assigned a greater weight, such as 0.7, while the domain knowledge database might be assigned a weight of 0.3. However, these weights can be dynamically adjusted based on the availability and number of self-reflection reports. If a substantial number of relevant self-reflection reports are available, the weight assigned to them can be increased to reflect their significance in informing the decision-making process. Conversely, if fewer self-reflection reports are available, the weight might be decreased, and more reliance could be placed on the domain knowledge database or other sources. This flexibility ensures that the confidence score accurately reflects the most reliable and comprehensive data available, allowing the thought assessor to make informed decisions even when data availability varies. By adjusting the weights, the system can maintain a balanced approach, leveraging the strengths of each data source to enhance the reliability of its recommendations.

The method 600 continues at decision block 608, by determining whether the confidence score is less than a threshold value, (i.e., is the proposed action is likely to result in a negative or positive outcome). If the assessment is confidence score is not less than the threshold value, the method proceeds to block 612, where the proposed action is executed and the outcome of the execution of the proposed action is observed. The execution of the action allows the system to implement the decision and observe the real-world results.

If the confidence score is less than the threshold value, the method 600 proceeds to block 610, where a rejection of the proposal is transmitted to the thought generator, which may cause the thought generator to generate an alternative action. This ensures that only viable proposals are acted upon, maintaining the effectiveness of the AI system. Following a rejection of the proposed action, as shown at block 618, the method 600 includes providing hypothetical feedback to the thought assessor 214 and the thought generator 212. This feedback offers insights into potential outcomes, helping to refine future proposals and assessments even for actions that were not executed.

In exemplary embodiments, hypothetical feedback is generated by simulating potential outcomes of actions that were proposed but not executed. This process involves analyzing the context and parameters of the rejected proposal to predict what might have occurred if the action had been taken. The AI system uses historical data, domain knowledge, and predictive models to create a plausible scenario, providing insights into the potential consequences of the action. This feedback is then used to refine the decision-making processes of the thought generator and Thought Assessor, even though the action was not actually performed.

In one example, consider an AI system used in a financial trading application. Suppose the thought generator proposes a trading action based on current market conditions, such as “buy 100 shares of Company X stock.” The thought assessor evaluates this proposal and assigns a confidence score that falls below the threshold, leading to the rejection of the action. To generate hypothetical feedback, the AI system simulates the potential outcome of executing the trade. It might analyze historical market data, trends, and similar past scenarios to predict how the stock price of Company X could have moved if the shares were purchased. The system might determine that, based on market volatility and recent news about Company X, the stock price could have increased by 5% over the next week. This hypothetical feedback is then provided to the thought generator and thought assessor, offering insights into the potential profitability of the rejected trade. The feedback helps refine future trading proposals by highlighting factors that could influence stock performance, such as market trends or company-specific news. By learning from these simulated scenarios, the AI system can improve its ability to make informed trading decisions in the future.

Next, as shown at block 614, the method 600 includes providing feedback, including the observed outcome of the action, to the thought assessor 214 and the thought generator 212. This feedback loop is used to refine the decision-making processes of both components, enhancing their accuracy and effectiveness. The method 600 also includes generating a self-reflection report based on the feedback, as shown at block 616. The self-reflection report summarizes the results and updates the experience knowledgebase 502, ensuring that the AI system 210 learns from each interaction and consistently enhances its decision-making capabilities.

In one embodiment, the threshold value for determining the confidence score of an action can be dynamically adjusted based on the context of the prompt, such as the complexity or sensitivity of the task at hand. For instance, in a healthcare application, the threshold might be set higher for important diagnostic decisions to ensure greater accuracy and reliability. In another embodiment, the threshold value could be influenced by the historical performance of the thought generator, where a consistent track record of successful outcomes allows for a lower threshold, thereby enabling more exploratory actions. Additionally, the threshold adjustment mechanism could incorporate real-time feedback from external systems, such as user satisfaction ratings or environmental changes, to fine-tune the decision-making process. This adaptability ensures that the system remains responsive to varying operational conditions and user requirements, enhancing the overall effectiveness and reliability across different domains, such as autonomous vehicle control or financial trading systems.

In one embodiment, the AI system employs reinforcement learning techniques to fine-tune the thought assessor and thought generator by utilizing a reward-based mechanism. This involves assigning positive reinforcement signals when the system's predictions align with successful outcomes, thereby encouraging similar future behavior. In another embodiment, the system incorporates supervised learning methods, where the thought assessor and thought generator are fine-tuned using labeled datasets that provide explicit examples of correct and incorrect actions. This approach allows the system to learn from historical data and improve decision-making accuracy.

In one embodiment, the AI system incorporates a feedback mechanism through its steering subsystem, which enhances the learning process by providing comprehensive feedback on both executed and rejected actions. After an action is performed, the steering subsystem observes the actual outcome and assesses whether the action led to a positive or negative result. This real-world feedback serves as a direct reward signal, reinforcing the decision-making process of the ai system. In exemplary embodiments, the steering subsystem is configured to generate hypothetical feedback for all proposed actions that were rejected. This involves simulating potential outcomes for these rejected actions, effectively asking, “If another action would have been performed, what outcome would have likely happened?” By analyzing the context and parameters of the rejected proposals, the steering subsystem predicts what might have occurred if those actions had been executed. This hypothetical feedback provides additional reward signals, offering insights into the potential consequences of alternative decisions. From a reinforcement learning perspective, this dual feedback mechanism significantly enriches the learning environment by providing more reward signals in each round of action. The actual outcome feedback helps fine-tune the AI system's decision-making capabilities by reinforcing successful actions and discouraging unsuccessful ones. Meanwhile, the hypothetical feedback allows the system to explore the potential benefits or drawbacks of alternative actions, enhancing its ability to generalize from past experiences and make more informed decisions in future scenarios. This embodiment ensures that the AI system continuously learns and adapts, not only from the actions it takes but also from those it considers and rejects. By leveraging both actual and hypothetical feedback, the system can optimize its decision-making processes, ultimately improving its performance and effectiveness across various applications.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for enhancing artificial intelligence decision-making with self-reflection and feedback mechanisms, the method comprising:
receiving a prompt from a user;
generating, in response to the prompt, an output by a thought generator, wherein the thought generator is configured to utilize one or more large language models to generate the output;
calculating, by a thought assessor based at least on one or more historical self-reflection reports from an experience knowledgebase, a confidence score for an action specified in the output;
based on a determination that the confidence score of the output exceeds a threshold value:
performing the action and observing an outcome of the action;
generating a self-reflection report based on the prompt, the output, and the outcome; and
storing the self-reflection report in the experience knowledgebase; and
fine-tuning the thought generator based on the outcome of the action.

2. The computer-implemented method of claim 1, further comprising transmitting a rejection of the action to the thought generator based on a determination that the confidence score of the action does not exceed the threshold value.

3. The computer-implemented method of claim 1, further comprising providing feedback to the thought assessor based on the outcome of the action.

4. The computer-implemented method of claim 3, further comprising fine-tuning the thought assessor based on the feedback.

5. The computer-implemented method of claim 4, wherein fine-tuning the one or more of the thought assessor and the thought generator includes reinforcement learning techniques to iteratively improve a performance of the one or more of the thought assessor and the thought generator based on the feedback.

6. The computer-implemented method of claim 1, wherein the confidence score is further based on data obtained from a domain specific knowledge database.

7. The computer-implemented method of claim 1, wherein the threshold value is dynamically adjusted based on one or more of a context of the prompt and a historical performance of the thought generator.

8. The computer-implemented method of claim 1, a steering system is configured to observe the outcome of the action and generate the self-reflection report.

9. The computer-implemented method of claim 8, wherein the steering system is further configured to generate a hypothetical feedback for a proposed actions that was not performed and update the self-reflection report based on the hypothetical feedback.

10. A system comprising:
a memory comprising computer readable instructions; and
a processing device for executing the computer readable instructions, the computer readable instructions controlling the processing device to perform operations comprising:
receiving a prompt from a user;
generating, in response to the prompt, an output by a thought generator, wherein the thought generator is configured to utilize one or more large language models to generate the output;
calculating, by a thought assessor based at least on one or more historical self-reflection reports from an experience knowledgebase, a confidence score for an action specified in the output;
based on a determination that the confidence score of the output exceeds a threshold value:
performing the action and observing an outcome of the action;
generating a self-reflection report based on the prompt, the output, and the outcome; and
storing the self-reflection report in the experience knowledgebase; and
fine-tuning the thought generator based on the outcome of the action.

11. The system of claim 10, wherein the operations further comprise transmitting a rejection of the action to the thought generator based on a determination that the confidence score of the action does not exceed the threshold value.

12. The system of claim 10, wherein the operations further comprise providing feedback to the thought assessor based on the outcome of the action.

13. The system of claim 12, wherein the operations further comprise fine-tuning the thought assessor based on the feedback.

14. The system of claim 13, wherein fine-tuning the one or more of the thought assessor and the thought generator includes reinforcement learning techniques to iteratively improve a performance of the one or more of the thought assessor and the thought generator based on the feedback.

15. The system of claim 10, wherein the confidence score is further based on data obtained from a domain specific knowledge database.

16. The system of claim 10, wherein the threshold value is dynamically adjusted based on one or more of a context of the prompt and a historical performance of the thought generator.

17. The system of claim 10, a steering system is configured to observe the outcome of the action and generate the self-reflection report.

18. The system of claim 17, wherein the steering system is further configured to generate a hypothetical feedback for a proposed actions that was not performed and update the self-reflection report based on the hypothetical feedback.

19. A computer program product for performing self-health checks in monitoring products, the computer program product comprising:
a set of one or more computer-readable storage media;
program instructions, collectively stored in the set of one or more storage media, for causing a processor set to perform the following computer operations:
receiving a prompt from a user;
generating, in response to the prompt, an output by a thought generator, wherein the thought generator is configured to utilize one or more large language models to generate the output;
calculating, by a thought assessor based at least on one or more historical self-reflection reports from an experience knowledgebase, a confidence score for an action specified in the output;
based on a determination that the confidence score of the output exceeds a threshold value:
performing the action and observing an outcome of the action;
generating a self-reflection report based on the prompt, the output, and the outcome; and
storing the self-reflection report in the experience knowledgebase; and
fine-tuning the thought generator based on the outcome of the action.

20. The computer program product of claim 19, wherein the operations further comprise transmitting a rejection of the action to the thought generator based on a determination that the confidence score of the action does not exceed the threshold value.
